(19) United States
(12) Patent Application Publication
(10) Pub. No.: US 2007/0296952 A1
(43) Pub. Date: Dec. 27, 2007

(54) Rotational speed apparatus

(76) Inventor: Aling Lai, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/474,946

(22) Filed: Jun. 27, 2006

(51) Int. Cl. G01P 3/40

(52) U.S. Cl. 356/23

(57) ABSTRACT

The present invention discloses a rotational speed apparatus that includes a main body, a light-transmitting liquid crystal display installed at the main body and a frequency adjusting button module. The liquid crystal display has an observing area which can be adjusted by a frequency adjusting button module to output a bright screen or a dark screen according to a predetermined frequency, and the light passing through the observing area is blocked periodically, so that a user can observe a rotating object through the observing area. If the rotating track of the measuring rotating object remains still, then a blinking frequency observed through the observing area can be used for measuring the rotational speed of the rotating object.

### FIELD OF THE INVENTION

The present invention relates to a rotational speed apparatus, and more particularly to a rotational speed apparatus that uses a parallax produced by the persistence of vision of human eyes to measure a rotational speed.

### BACKGROUND OF THE INVENTION

At present, many technologies are provided for measuring the rotational speed of an object, such as a photoelectric rotational speed meter is used for measuring the rotational speed of a rotating object (such as a fan vane), and the photoelectric rotational speed meters are divided into two types: transmission photoelectric rotational speed meters and reflecting photoelectric rotational speed meters. For example, the transmission photoelectric rotational speed meter receives a natural light source from another side of a fan vane by an optical receiver (such as a photosensitive resistor and a photo transistor), and the time interval for projecting the light source onto the optical receiver (such as a photosensitive resistor and a photo transistor) is used for computing the rotational speed of the fan vane. On the other hands the reflecting photoelectric rotational speed apparatus uses a general light source transmitted to reflected by the fan vane to replace the natural light source, and similarly the time interval for the optical receiver (such as a photosensitive resistor and a photo transistor) to receive the light is used for computing the rotational speed of the fan vane.

Another technology employs a flash light synchronous rotational speed apparatus and bases on the principle of persistence of vision of human eyes to emit light with a constant frequency, and the light is transmitted to a rotating fan vane, such that if an observer observes the fan vane and the blinking frequency of the flash-light meter is less than the fan van rotating frequency, then the fan vane visually rotates clockwise due to the fan vane rotating frequency exceeds the blinking frequency. If the blinking frequency of the flash-light meter is higher than the fan van rotating frequency, the fan vane visually rotates counterclockwise with a constant speed. If the flash signal frequency is equal to the fan van rotating frequency, the fan vane visually remains still, since the fan van rotating frequency is synchronous with the blinking frequency. By then, the blinking frequency is equal to the fan vane rotating frequency.

A technology similar to the aforementioned technology is called frequency type rotational speed measurement. Referring to FIG. 7, a main body 7 of the rotational speed apparatus includes a set of rotating motor 71 for driving a rotating object 72 to rotate (as shown in FIG. 8), and the rotating object 72 has a through groove 721 disposed axially on the rotating object 72, and the main body 7 includes a vertically penetrating observing window 73 disposed at a position corresponding to the rotating object 72.

Referring to FIGS. 7 to 9, a user can observe a flying helicopter through the observing window 73, and the rotation frequency of the motor 71 can be adjusted until the helicopter propeller 8 is found to be in a motionless state. By then, the rotation frequency of the motor 71 can be used for computing the rotation frequency of the helicopter propeller 8, and the computed rotation frequency will be displayed on a display window 74 at the lower side of the observing window 73 of the main body 7.

However, the technology of the frequency type rotational speed measurement has the following shortcomings:

1. The motor 71 cannot operate at a low rotational speed, and its linearity is poor.

2. The motor 71 is power-consuming, oversized and overweight.

3. The flexibility of the design is restricted by the properties of the motor 71 (such as its volume) and the observing window 73 (such as its area). If it is necessary to increase the area of the observing window 73, then the volume of the motor 71 will be increased accordingly. Since the observing window 73 is penetrated vertically, therefore the position for installing a component such as the display window in the main body 7 will be limited, when it is necessary to design the position of the observing window 73.

### SUMMARY OF THE INVENTION

In view of the shortcomings of the prior art, the inventor of the invention based on years of experience in the related industry to conduct extensive researches and experiments, and finally invented a rotational speed apparatus in accordance with the present invention.

Therefore, it is a primary objective of the present invention to provide a feasible solution and overcome the foregoing problems by providing a rotational speed apparatus that comes with a small volume, a light weight, a large observing area and a better linearity (or a low inaccuracy).

To achieve the foregoing objective, the present invention comprises:

a main body, having a top side, a bottom side corresponding to the top side, and a display window main body penetrating from the top side to the bottom side of the main body;

a light-transmitting liquid crystal display, installed at the display window of the main body, and having an observing area for outputting a bright screen or a dark screen according to a predetermined frequency and periodically blocking a light passing through the observing area; and

a frequency adjusting button module, installed at the main body, for adjusting an output frequency of a bright screen or a dark screen of the liquid crystal display.

### BRIEF DESCRIPTION OF THE DRAWINGS

FIG. 1 is a perspective view of the present invention;

FIG. 2 is a schematic view of a dark screen status of an observing area of the present invention;

FIG. 3 is a schematic view of a bright screen status of an observing area of the present invention;

FIG. 4 is a schematic view of an observing area without a frequency correction according to the present invention;

FIG. 5 is a schematic view of an observing area with a frequency correction according to the present invention;

FIG. 6 is a perspective view of a second preferred embodiment of the present invention;

FIG. 7 is a schematic view of the structure of a prior art rotational speed apparatus;

FIG. 8 is a schematic view of the structure of a motor and a rotational object of a prior art rotational speed apparatus; and

FIG. 9 is an enlarged view of a prior art observing window.

### DETAILED DESCRIPTION OF THE PREFERRED EMBODIMENTS

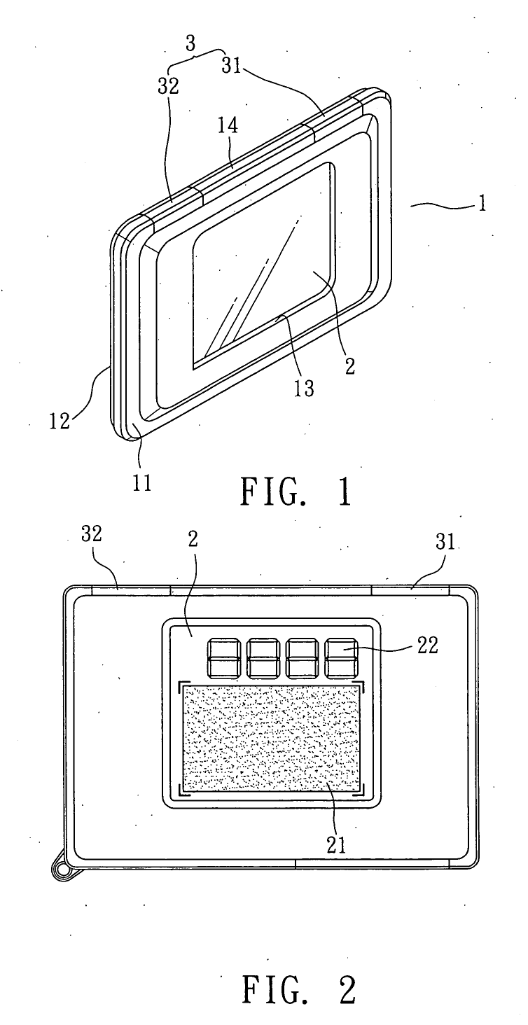

Referring to FIGS. 1 and 2 for a structure of a preferred embodiment of the present invention, the structure of this embodiment is provided for illustrating the invention, but the invention is not limited to such structure.

This embodiment comprises a main body 1, a light-transmitting liquid crystal display 2 installed at the main body 1 and a frequency adjusting button module 3.

The main body 1 has a top side 11, a bottom side 12 corresponding to the top side 11, and a display window 13 penetrating from the top side 11 of the main body 1 to the bottom side 12 of the main body 1; wherein the main body defines a lateral edge 14 disposed adjacent to the top side 11 and the bottom side 12, and the frequency adjusting bottom module 3 is installed at the lateral edge 14 of the main body 1, and the frequency adjusting button module 3 includes a frequency increasing button 31 and a frequency decreasing button 32. A user can adjust the output frequency of a bright screen or a dark screen of the observing area 21 in the liquid crystal display 2 by the frequency adjusting button module 3.

The liquid crystal display 2 is installed at a display window 13 of the main body 1, and the liquid crystal display 2 has an observing area 21, and the observing area 21 outputs a bright screen or a dark screen (which is a constantly blinking observing area) according to a predetermined frequency and periodically blocks a light passing through the observing area 21. In this embodiment, the liquid crystal display 2 has a frequency indicating area 22 disposed at a position proximate to the observing area 21 for displaying the brightness switching frequency of the observing area 21 on the frequency indicating area 22.

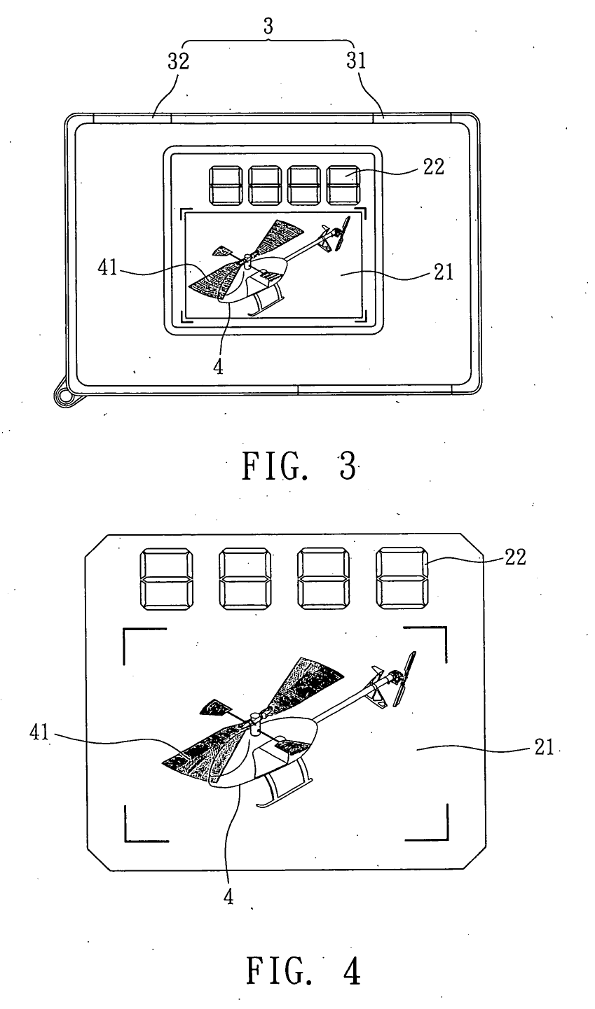

When using the rotational speed apparatus, a user aligns the display window towards a measuring object (such as a model helicopter 4) and the user observes a propeller 41 of the helicopter 4. Referring to FIGS. 2 and 3, the observing area 21 of the liquid crystal display 1 will alternately show bright and dark screens. In FIG. 2, a dark screen of the observing area 21 appears, and thus the light cannot pass through, and there is no image of the helicopter 4. In FIG. 3, the light passes through the observing area 21 of the liquid crystal display 2, and thus the user can observe the image of the helicopter 4.

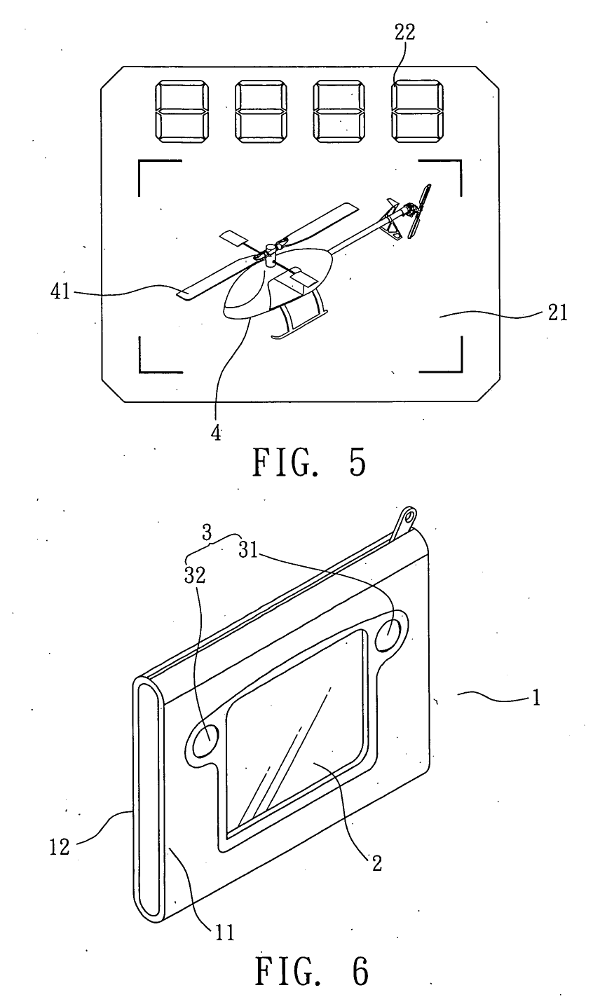

Referring to FIGS. 3 to 5, a user can press the frequency increasing button 31 and the frequency decreasing button 32 by the index fingers of both hands to adjust the frequencies and observes the screen from the observing area 21 as shown in FIG. 4. The moving track of the propeller 41 of the helicopter 4 is moved until a still screen of the propeller 41 as shown in FIG. 5 appears. By then, the display frequency of the frequency indicating area 22 is equal to the rotational speed of the propeller 41.

In the present invention, the liquid crystal drives the observing area 21 to blink, and thus its advantages include a low driving voltage, a low power consumption, and a large area of the observing area 21 which makes the measurement more convenient to the users, and its light and thin design facilitates the carrying and operation of rotational speed apparatus. Further, the highly flexible design only requires a design of the liquid crystal display 2, and there will be no conflict on the space arrangement of the frequency indicating area 22 and the observing area 21.

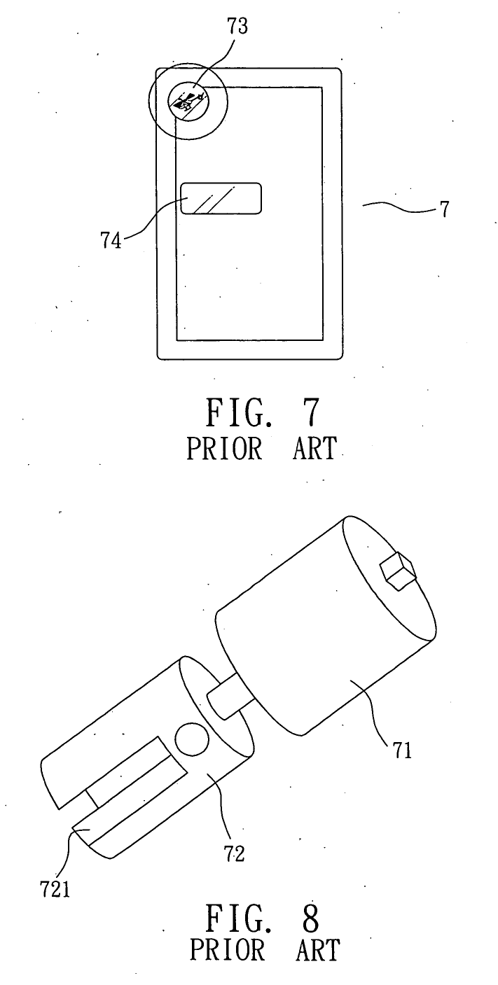

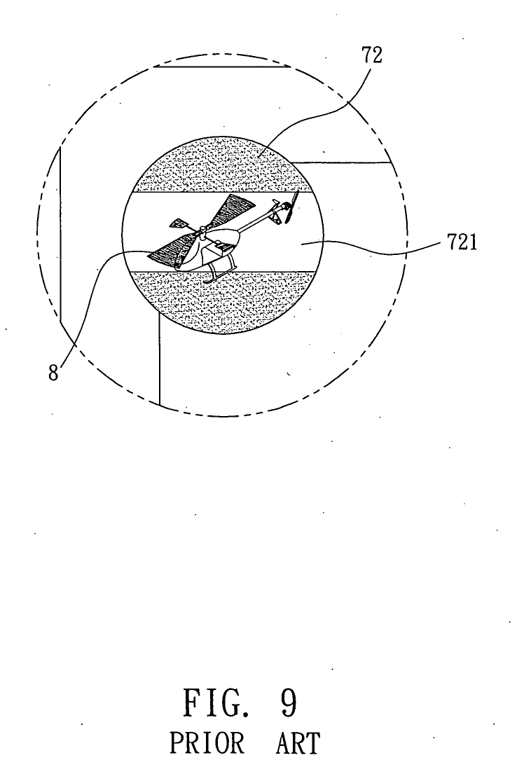

Of course, many other embodiments of the invention exist, and there are changes on the details only. Referring to FIG. 6 for a second preferred embodiment of the present invention, the frequency adjusting button module 3 is installed at the top side 11 of the main body 1, and the frequency increasing button 31 and the frequency decreasing button 32 of the frequency adjusting bottom module 3 are installed on both sides of the display window 2 respectively to facilitate users to press the frequency increasing button 31 and the frequency decreasing button 32 of the frequency adjusting bottom module 3 by the thumbs of both hands and adjust the frequency.

What is claimed is:

1. A rotational speed apparatus, comprising:
a main body, having a top side, a bottom side corresponding to said top side, and
a display window main body penetrating from said top side to said bottom side of said main body;
a light-transmitting liquid crystal display, installed at said display window of said main body, and having an observing area for outputting a bright screen or a dark screen according to a predetermined frequency and periodically blocking a light passing through said observing area; and
a frequency adjusting button module, installed at said main body, for adjusting an output frequency of a bright screen or a dark screen of said liquid crystal display.

2. The rotational speed apparatus of claim 1, wherein said frequency adjusting button module comprises a frequency increasing button and a frequency decreasing button, and said main body defines a lateral edge disposed adjacent to said top side and said bottom side.

3. The rotational speed apparatus of claim 2, wherein said frequency adjusting button module is installed on said top side of said main body, and said frequency increasing button and said frequency decreasing button of said frequency adjusting button module are installed on both sides of said display window respectively.

4. The rotational speed apparatus of claim 2, wherein said frequency adjusting button module is installed at a lateral edge of said main body.

5. The rotational speed apparatus of claim 1, wherein said liquid crystal display comprises a frequency indicating area disposed at a position proximate to said observing area.
